(19) United States
(12) Patent Application Publication
(10) Pub. No.: US 2024/0092173 A1
(43) Pub. Date: Mar. 21, 2024

(54) DASHBOARD CONTROL SYSTEM

(71) Applicant: TVS MOTOR COMPANY LIMITED, Chennai (IN)

(72) Inventors: Jabez Dhinagar Samraj, Chennai (IN); Venkatachalapathi Aravindh Balaji, Chennai (IN); Subbiah Senthilnathan, Chennai (IN); Venu Sudarshan, Chennai (IN); Geddadi Krishnamohan, Chennai (IN)

(73) Assignee: TVS MOTOR COMPANY LIMITED, Chennai (IN)

(21) Appl. No.: 18/255,434

(22) PCT Filed: Oct. 20, 2021
(86) PCT No.: PCT/IN2021/050996

§ 371 Date: Jun. 1, 2023

(30) Foreign Application Priority Data
Dec. 1, 2020 (IN) 202041052326

(51) Int. Cl. B60K 37/06; B60R 11/02

(52) U.S. Cl. CPC B60K 37/06; B60R 11/0235; B60K 2370/52; B60K 2370/67; B60R 2011/0005

(57) ABSTRACT

A dashboard control system of a vehicle includes: one or more sensors positioned in the vehicle for generating sensor outputs; one or more control inputs located on at least one of the vehicle and a user device communicatively coupled to the vehicle; and a dashboard assembly positioned in the vehicle facing a rider of the vehicle, the dashboard assembly including at least one visor unit coupled with a rotatable display unit with at least one display face. The rotatable display unit includes at least one drive unit and at least one controller for controlling operation of at least one of the at least one visor unit and the rotatable display unit, based on the sensor outputs and the one or more control inputs.

### TECHNICAL FIELD

The present subject matter relates to a dashboard assembly of a vehicle. More particularly, a dashboard control system for controlling operation of the dashboard assembly of the vehicle is disclosed.

### BACKGROUND

A vehicle, generally a two wheeled vehicle or a three wheeled vehicle is equipped with dashboard assembly that is positioned proximal to the handle bar or steering wheel of the vehicle. The dashboard assembly may comprise of plurality of systems e.g. various meters conveying the information of the vehicle, means to lock and unlock the vehicle, a visor, etc. In addition to the visor, the vehicle may have a windshield affecting the aerodynamics of the vehicle. The meter on the dashboard assembly is positioned in the viewing direction of the rider of the vehicle to display information and receive inputs from the user. With the advent of technology, the means to convey vehicle information to the rider is evolving and thus, the components of the dashboard assembly are no longer limited to analog meters. The analog meters have evolved to become digital meters, electronic display units, LCD panels, etc., and the meter visor is needed to protect these display means of the dashboard assembly. Thus, the design and operation of the evolving dashboard assembly of the vehicle is critical to the readability, accessibility, and informative display to the rider of the vehicle resulting in ride comfort, convenience, and ease of usage of the vehicle.

### BRIEF DESCRIPTION OF THE DRAWINGS

FIG. 1 exemplarily illustrates a perspective view of a handle bar assembly of a vehicle;

FIG. 2 exemplarily illustrates a block diagram of a dashboard control system for controlling operation of a dashboard assembly exemplarily illustrated in FIG. 1;

FIG. 3 exemplarily illustrates a schematic diagram of a visor drive unit in a rotatable display unit exemplarily illustrated in FIG. 2;

FIG. 4 exemplarily illustrates a schematic diagram of a rotatable display drive unit in the rotatable display unit exemplarily illustrated in FIG. 2;

FIG. 5 exemplarily illustrates a flowchart showing a method for controlling operation of the dashboard assembly of the vehicle by the dashboard control system shown in FIG. 2;

FIGS. 6A-6B exemplarily illustrate a flowchart comprising steps for authorization of access of the vehicle by a controller of the dashboard control system;

FIGS. 7A-7B exemplarily illustrate a flowchart comprising steps for actuation of the visor unit to at least partially move in an opening direction by the controller;

FIG. 8 exemplarily illustrates a flowchart comprising steps for movement of the visor unit in the opening direction and positioning of the visor unit in the manual mode by the controller;

FIG. 9 exemplarily illustrate a flowchart comprising steps for movement of the visor unit in the opening direction and positioning of the visor unit based on the user application, by the controller;

FIGS. 10A-10B exemplarily illustrate a flowchart comprising steps for movement of the visor unit in the opening direction and positioning of the visor unit in the automatic mode, by the controller;

FIGS. 11A-11B exemplarily illustrate a flowchart comprising steps for movement of the visor unit in the opening direction and positioning of the visor unit in the standard mode, by the controller;

FIGS. 12A-12B exemplarily illustrate a flowchart comprising steps for actuation of the visor unit to at least partially move in the closing direction by the controller;

FIGS. 13A-13B exemplarily illustrate a flowchart comprising steps for actuation of the visor unit to at least partially move in the opening direction by the controller, in the automatic mode, by the controller, in the running condition of the vehicle; and

FIGS. 14A-14B exemplarily illustrate a flowchart comprising steps for actuation of the rotatable display unit to rotate and display a selected display face, by the controller.

### DETAILED DESCRIPTION OF THE INVENTION

Analog meters or the display units in the dashboard assembly which convey information, such as, speed of the vehicle, fuel tank level, battery level, distance travelled, etc., are positioned in a direction facing the rider of vehicle. During the course of the ride, the meters or the display units are exposed to sunlight, dust, and rain and visibility of the vehicle information on dashboard assembly is reduced. The display unit may be subjected to glare due to the sunlight and readability gets reduced. Also, during the vehicle parked condition, the continuous prolonged exposure of the display units and the analog meters to high intensity sunlight may damage them. Additionally, the existing visor of the vehicle is fixed to the frame of the vehicle and is designed to protect the rider from direct contact with travelling wind, reduce aerodynamic drag resistance and protect the meters from flying insects, gravel, and rain only to a limited extent. Without proper protection to the meters and the display units, the readability of the vehicle information is hampered which can potentially lead to a mishap or untoward incident. Thus, there is a need to protect the meters and the display units from prolonged exposure to sun in parked condition.

To address this need, a solution could involve providing a cover on the meters and the display units, while parking the vehicle. However, the cover needs to be retracted or docked elsewhere during the course of ride of the vehicle, as the meters and the display units ought to be visible to the rider. Also, if the cover is provided in addition to the visor behind the display units, the number of the mountings on the frame structure of the vehicle increases. To make place for the visor and the cover on the available frame member, the meters and the display units will have to be positioned more closer to the rider, hindering readability of the meters and the display unit by the rider. Further, if the cover is to be used to partially cover the meters and the display units to avoid glare, the cover needs to be docked at different adjustable positions based on the anthropometry and comfort of the user. However, this would require additional manual intervention by the user during the course of the ride, distracting the rider and may lead to a mishap. Therefore, there is a need for a design of multi-functional visor of the vehicle that serves the purpose of a visor and a cover on the meters and the display unit, while not involving any manual intervention by the rider.

Also, since the visor functions like a cover over the display units and meters, there is a need to unlock the vehicle to access display units. For the comfort and convenience of the rider, the access to the vehicle need not be limited to use of a manual key and lock assembly in the vehicle. A keyless authorization means may be provided in the visor of the vehicle for accessing the vehicle. Also, the layout of the meters and the display units is generally flat requiring the user to sometimes bend and have a glance of the information being conveyed. This distracts the rider in the course of driving the vehicle. There is a need for the display units and the meters to be positioned ergonomically, catering to riders of different genders and heights, providing ease in readability by being in the rider's cone of vision and being accessible within anthropometric reach. Further, the layout of the dashboard assembly needs to be discrete and neat for conveying different kinds of information to the riders. The information conveyed by the analog meters, such as speed, fuel tank level, etc., is different from the information conveyed by the digital display unit, such as, call records, mode of the vehicle, etc. The combination of the analog meters and the display units together tends to distract the rider. Also, the preferences of the riders tend to vary, with the older generation being comfortable with minimum information for a safe ride and the younger generation craving for additional features in the form of display units which is also substantiated by rider age based cognitive abilities to comprehend and process diverse set of simultaneous information being displayed. There is a need for design of the dashboard assembly to cater to the preferences of different generations, genders while also designing the display of the information in a neat and non-clumsy manner while still being multi-functional. Further, there is a need for conveying vehicle information to the rider during the ride and a need for providing entertainment means to the rider during the vehicle parked condition using the meters and the display unit. Further, there is a need for controlling the positioning of the display units and the multi-functional visor at angles and heights desired by the rider of the vehicle, without requiring any manual intervention. The selection of the desired position of the visor has to be performed effortlessly by the rider of the vehicle or by the visor itself sensing surrounding parameter, to give the rider of the vehicle all comfort with the additional capabilities of the visor.

Also, the selection of the display unit or meters the rider wants to view should be effortless to riders of different categories. The change between the display unit and the meters based on the choice of the rider needs to be performed neatly, without distracting and disturbing the user. Further in case a fault occurs in the change between the display unit and meters, the fault needs to be indicated to the user and without the display units and meters, the vehicle must be usable and capable of being safely navigated to desired destination.

Therefore, there is a need for an improved design of a control system for a multi-faceted ergonomic modular dashboard assembly comprising meters, display units and a visor in a vehicle that ensures protected discrete and neat display of information, based on rider preferences, while also ensuring rider comfort, convenience, safety, readability, and accessibility overcoming all problems disclosed above as well as other problems of known art.

In an embodiment of the present invention, a dashboard control system is disclosed. The dashboard control system in communication with a vehicle control unit controls the operation of a dashboard assembly of a vehicle. The dashboard control system comprises one or more sensors positioned in the vehicle for generating sensor outputs, one or more control inputs located on at least one of the vehicle and a user device communicatively coupled to the vehicle; and the dashboard assembly positioned in the vehicle facing a rider of the vehicle. The dashboard assembly comprises at least one visor unit coupled with a rotatable display unit with at least one display face. The rotatable display unit comprises at least one drive unit and at least one controller for controlling the operation of at least one of the at least one visor unit and the rotatable display unit, based on the sensor outputs and the one or more control inputs.

In an embodiment, the at least one visor unit is configured to at least partially cover the rotatable display unit underneath and the at least one visor unit is controlled by the at least one controller to move in one of an opening direction and a closing direction to one of expose and cover the rotatable display unit. The visor unit comprises a wireless communication board for providing keyless access to the vehicle and a secondary display unit for displaying vehicle status information, alerts, and notifications and branding of the vehicle.

At least one drive unit of the rotatable display unit comprises a secondary display drive unit, a visor drive unit, an analog dial drive unit, and a rotatable display drive unit. The visor drive unit operably coupled to the at least one controller comprises at least one angle sensor and a motor controller operably coupled to a motor for positioning the visor unit at a selected position. The rotatable display drive unit operably coupled to the at least one controller comprises at least one angle sensor, a motor controller, and a motor for positioning the display unit with a selected display face.

The at least one display face comprises an analog display unit, an electronic display unit for displaying vehicle status information, alerts, and notifications, and a vehicle body element in flush layout with mounting location of the dashboard assembly in the vehicle. The electronic display unit comprises a display interface communicatively coupled to at least one display controller, at least one secondary sensor, and one or more connectivity supporting hardwares.

The at least one controller of the dashboard assembly controls one or more a keyless access of the vehicle using the at least one visor unit, rotation of the rotatable display unit, movement of the at least one visor unit in an opening direction and a closing direction, and positioning of the rotatable display unit and the visor unit at a position selected by the rider of the vehicle based on the control inputs and the sensor outputs. The control inputs comprise one or more of switches provided on the dashboard assembly, switches on the handle bar of the vehicle, switches on the vehicle body panels proximal to the rider of the vehicle, an input in a user application of the user device connected to the vehicle, a voice command to the at least one visor unit, and a voice command to the rotatable display unit.

The control inputs are configured to select a mode of operation of the visor unit, select a mode of operation of the rotatable display unit, select a display face of the rotatable display unit to be facing the rider of the vehicle, and select a default display face of the rotatable display unit facing the rider of the vehicle.

In another embodiment, a method for controlling the dashboard assembly of the vehicle by the dashboard control system is disclosed. The method comprises the steps of: authorizing access to the vehicle based on an input from a user device on the visor unit by the at least one controller; actuating the visor unit for moving in one of an opening direction and a closing direction, by the at least one controller based on at least one of the sensor output, the one or more control inputs, and a vehicle condition; and actuating the rotatable display unit for rotating and displaying a selected display face by the at least one controller, based on the sensor output and a selection of the one or more control inputs.

The controller authorizes the rider based on the vehicle condition. The vehicle condition is one of a vehicle ignition ON condition, a vehicle ignition OFF condition, a vehicle stationary condition, and a vehicle running condition. In an embodiment, the method comprises the step of changing the vehicle condition to vehicle ignition OFF condition by the vehicle control unit on determining vehicle ignition ON condition and actuating the visor unit for moving in the closing direction by the at least one controller based on the vehicle ignition OFF condition. In an embodiment, the method comprises the step of changing the vehicle condition to vehicle ignition ON condition by the vehicle control unit on determining vehicle ignition OFF condition and actuating the visor unit for moving in the opening direction by the at least one controller of the dashboard control system based on the vehicle ignition ON condition. In both these embodiments, the vehicle control unit disables a drive mode of the vehicle prior to actuating the visor unit for moving in the one of the opening direction and the closing direction by the at least one controller. The vehicle control unit enables a drive mode of the vehicle after at least partial movement of the visor unit in the opening direction on actuation by the at least one controller.

The secondary display unit of the visor unit displays vehicle authorization status information and vehicle status information, based on the authorization of the rider by the at least one controller. Further, the controller displays the rotatable display unit status information on the secondary display unit, on determining a fault in positioning the selected display face of the rotatable display unit. Further, the controller displays the vehicle status information and visor unit fault status on the secondary display unit on determining a fault in driving the visor unit.

The method comprises the step of actuating the visor unit to move in the closing direction by the at least one controller, prior to actuation of the rotatable display unit for rotating and displaying the selected display face. Prior to actuating the visor unit to move in the closing direction, the controller determines the display face of the rotatable display unit facing the rider of the vehicle.

The method comprises the step of actuating the visor unit comprising actuating a motor controller operably coupled to a motor of the visor drive unit by the at least one controller based on the one or more control inputs, a preconfigured rotation direction, status of fault registers of the motor controller, and the sensor output from at least one angle sensor of the visor drive unit for positioning the visor unit at a selected position. In an embodiment, actuating the visor unit for positioning the visor unit at the selected position comprises computing an angle of positioning the visor unit by the at least one controller and driving the motor controller operably coupled to the motor of the visor drive unit to the computed angle, based on the sensor output and almanac information of a day. In another embodiment, actuating the visor unit for positioning the visor unit at the selected position comprises receiving visor angle as an input from one of the one or more control inputs and driving the motor controller operably coupled to the motor of the visor drive unit to the received visor angle.

In an embodiment, the step of actuating the rotatable display unit comprises actuating a motor controller operably coupled to a motor of the rotatable display drive unit by the at least one controller based on the one or more control inputs, a preconfigured rotation direction, status of fault registers of the motor controller, and the sensor output from at least one angle sensor of the rotatable display drive unit for displaying the selected display face to the rider of the vehicle. In an embodiment, the step of actuating the rotatable display unit for positioning the display face of the rotatable display unit comprises computing an angle of rotation of the rotatable display unit by the at least one controller based on the selected display face by the rider and driving the motor controller operably coupled to the motor of the rotatable display drive unit to the computed angle. In an embodiment, the motor controller is actuated by the at least one controller to control both the visor unit and the rotatable display unit.

The present subject matter is further described with reference to accompanying figures. It should be noted that the description and figures merely illustrate principles of the present subject matter. Various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

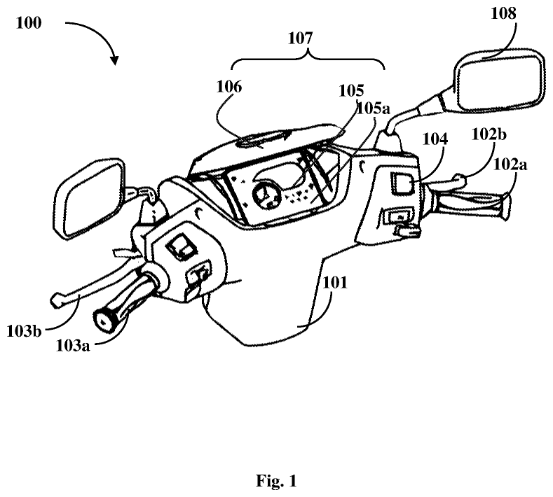

FIG. 1 exemplarily illustrates a perspective view of a handle bar assembly 100 of a vehicle. The vehicle may be a saddle type vehicle, a step through vehicle, a motorcycle, a three-wheeled vehicle, an electric vehicle, a hybrid vehicle, an IC engine vehicle, etc. Considered here as an example is the handle bar assembly 100 of a two-wheeled vehicle comprising a handle bar crown, and a left handle bar and a right handle bar extending in opposite directions from the handle bar crown. Each of the left handle bar and the right handle bar comprises a grip 102a, 103a respectively, a brake lever 102b, 103b respectively, and a cluster of plurality of switches 104. The grip 102a of the right handle bar may be used as a throttle grip. Further, the handle bar assembly 100 comprises a handle bar cover 101. In an embodiment, the handle bar cover 101 may be in two pieces: a front handle bar cover mounted from the front of the vehicle and the rear handle bar cover proximal to the rider of the vehicle. The front handle bar cover comprises provisions to house the headlamp assembly and/or the turn signal indicators. The rear handle bar cover substantially encloses the left handle bar, the right handle bar, and the handle bar crown and extends till the grip 102a, 103a of each of the handle bars. The cluster of switches 104 is disposed on the top surface of the handle bar cover 101. The handle bar cover 101 further has provisions to mount the rear-view mirrors 108, other accessories, and the dashboard assembly 107. The dashboard assembly 107 is accommodated in the handle bar cover 101 in the region between the grips 102a, 103a of the handle bars and positioned facing a rider of the vehicle.

The dashboard assembly 107 comprises at least one visor unit, such as, 106 coupled with a rotatable display unit 105. The display unit 105 may have at least one display face, such as, 105a. The display face 105a may be an analog display unit as exemplarily illustrated in FIG. 1, an electronic display unit for displaying vehicle status information, alerts, and notifications, and a vehicle body element in flush layout with the handle bar cover 101. The visor unit 106 may be movable and may slidably engage with the handle bar cover 101. The slidably engaged visor unit 106 may partially or completely cover and uncover the display faces, such as, 105a of the display unit 105, as per the preferences of the rider of the vehicle. In an embodiment, the display face may be a vehicle body element in flush layout with mounting location of the dashboard assembly 107 on the handle bar cover 101 in the vehicle.

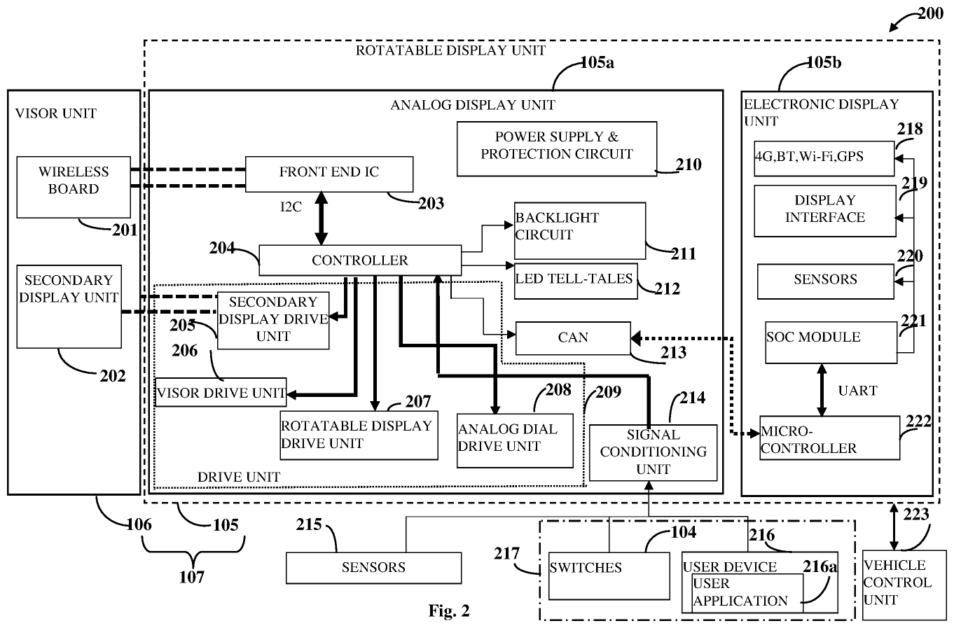

FIG. 2 exemplarily illustrates a block diagram of a dashboard control system 200 for controlling operation of the dashboard assembly 107 exemplarily illustrated in FIG. 1. In addition to the dashboard assembly 107, the dashboard control system 200 comprises one or more sensors 215 positioned in at least one part of the vehicle for generating sensor outputs and one or more control inputs 217 located on at least one of the vehicle and a user device 216 communicatively coupled to the vehicle. The sensors 215 in the vehicle may be ambient light sensors, speed sensors, temperature sensors, gyroscopes, accelerometer, side stand sensor, telematics unit, position sensors, etc. The sensors 215 may be positioned on the dashboard assembly 107 or on any part of the vehicle. The cluster of plurality of switches 104 on the handle bar cover 101 is one of the control inputs 216 of the dashboard control system 200. The other control inputs 217 may be switches provided on the dashboard assembly 107, switches on the vehicle body panels proximal to the rider of the vehicle, an input in a user application 216a of the user device 216 connected to the vehicle, a voice command to the visor unit 106, and a voice command to the rotatable display unit 105. The control inputs 217 are configured to select a mode of operation of the visor unit 106, select a mode of operation of the rotatable display unit 105, select a display face 105a, 105b of the rotatable display unit 105 to be facing the rider of the vehicle, and select a default display face 105a of the rotatable display unit 105 facing the rider of the vehicle, etc.

The user device 216 may be a smart phone, a tablet, a laptop, or a wearable device, such as, a smart helmet, a smart bracelet, a smart ring, etc., in possession of the rider of the vehicle and has the capabilities of wirelessly communicating with the vehicle. The user device 216 may have the user application 216a installed in it that is compatible and linked with an operating system of the rotatable display unit 105 of the dashboard control system 200. The rotatable display unit 105 is at least partially exposed to be visible in the cone of vision of the rider by the opening of the visor unit 106 as exemplarily illustrated in FIG. 1. The rotatable display unit 105 is covered by the visor unit 106 in a closed condition of the visor unit 106. The rotatable display unit 105 comprises at least one drive unit 209 for driving the visor unit 106 and the rotatable display unit 105 and at least one controller 204 for controlling operation of the visor unit 106 and the rotatable display unit 105, based on the sensor outputs and the control inputs 217.

The visor unit 106 at least partially covers the rotatable display unit 105 underneath and the controller 204 controls the visor unit 106 to move in an opening direction or a closing direction to expose or cover the rotatable display unit 105. In an embodiment, the visor unit 106 slides and retracts to stand vertically to form the visor or the windshield of the vehicle. The visor unit 106 comprises a wireless communication board 201 for providing keyless access to the vehicle and a secondary display unit 202 embedded within the visor unit 106. The wireless communication board 201 may be a NFC reader, a Bluetooth module, etc., that has a capability to authenticate the user device 216, such as, a NFC tag in possession with the rider and unlock/lock the vehicle. The keyless authorisation of the vehicle may be used for starting the vehicle and stopping the vehicle.

The secondary display unit 202 may display the basic functionalities of the rotatable display unit 105, in the case where the rotatable display unit 105 is covered by the visor unit 106. The secondary display unit 202 may be a configurable dot matrix RGB display unit. The secondary display unit 202 may be used for branding of the vehicle, such as, to display company logo or brand name in the direction facing the rider in the closed condition of the visor unit 106. In another embodiment, the secondary display unit 202 may function as a day time miming lamp. The secondary display unit 202 may also display vehicle status information, such as, vehicle speed, faults in the vehicle, faults in the operation of the visor unit 106 and the rotatable display unit 105, alerts, and notifications such as, call notifications, SMS notifications, user application notifications, etc.

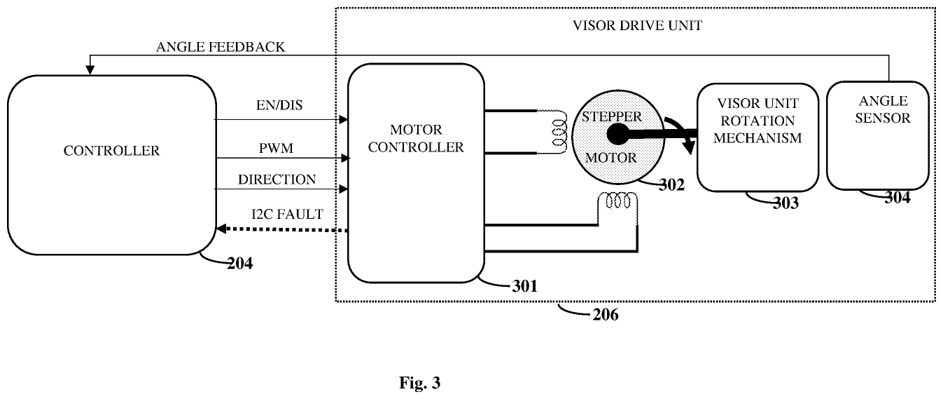

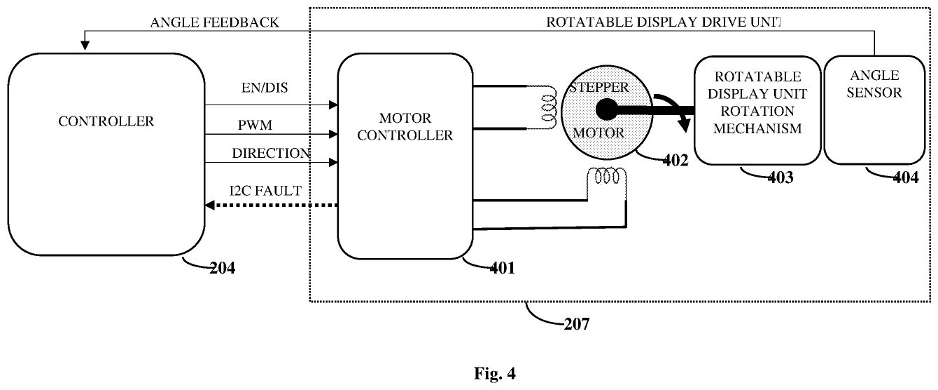

The rotatable display unit 105 comprises at least one display face 105a, 105b. That is, the rotatable display unit 105 may comprise multiple display faces 105a, 105b positioned at different angles. The rotatable display unit 105 as exemplarily illustrated comprises two display faces: an analog display unit 105a and an electronic display unit 105b positioned at 180 degrees from each other. The analog display unit 105a includes the drive unit 209 and the controller 204 as exemplarily illustrated. The drive unit 209 drives both the visor unit 106 and the rotatable display unit 105. The drive unit 209 comprises a secondary display drive unit 205, a visor drive unit 206, a rotatable display drive unit 207, and an analog dial drive unit 208. The visor drive unit 206 drives a motor for positioning the visor unit 106 at a selected position. The visor drive unit 206 is operably coupled to the controller 204 and comprises at least one angle sensor and a motor controller is operably coupled to a motor for positioning the visor unit 106 at a selected position as shown in FIG. 3. The rotatable display drive unit 207 rotates the display faces 105a, 105b, thereby bringing one of the multiple display faces in line of sight of the rider within the cone of vision. The rotatable display drive unit 207 is operably coupled to the controller 204 and comprises at least one angle sensor, a motor controller, and a motor for positioning the analog display unit and the electronic display unit as shown in FIG. 4. The secondary display drive unit 205 drives the secondary display unit 202 of the visor unit 106. The communication between the main controller 204 of the rotatable display unit 105 and the secondary display unit 202 is implemented using serial peripheral interface (SPI), I2C, LIN, etc. The secondary display drive unit 205 uses closed loop current control for controlling the luminous intensity of the LED's of the secondary display unit 202. The analog dial drive unit 208 drives the needle of the analog meters of the analog display unit 105a with zero and end point detection along with fault diagnostic feedback.

The analog display unit 105a additionally includes a signal conditioning unit 214 consisting of ESD (Electrostatic Discharge) protection, filter circuit, diodes, etc., for conditioning of the signals being communicated between the rotatable display unit 105, the visor unit 106, and a vehicle control unit 223 of the vehicle. The analog display unit 105a further includes a CAN transceiver circuit 213 for communication with the vehicle control unit 223 and/or the electronic display unit 105b and LED tell tales 212, such as, indicators for turn signal lamps, malfunction indication, high beam indicator, gear indicator, meters such as, speedometer, odometer, fuel level, battery charge level indicators, etc.

To communicate with the wireless communication board, such as, the NFC reader 201 in the visor unit 106 or the user device 216 and to authorize access to the vehicle, the analog display unit 105a comprises a NFC Front-end IC 203. Further, the analog display unit 105a comprises a backlight circuit 211 that regulates and supplies backlight current for the analog display unit 105a, the electronic display unit 105b, as well as the secondary display unit 202. The analog display unit 105a comprises a power supply and protection circuit 210 for converting the battery supply voltage to low voltages required for various circuits in the dashboard assembly 107. Protections, such as, reverse voltage protection, high voltage protection, and/or transient voltage protection of the dashboard assembly 107 are provided by the protection circuit 210.

The electronic display unit 105b comprises a display interface 219 communicatively coupled to at least one display controller 221, 222, at least one secondary sensor 220, and one or more connectivity supporting hardwares 218. The electronic display unit 105b comprises connectivity features, such as, cellular, GPS navigation, Bluetooth, Wi-Fi, etc., sunlight readable high-performance display interface 219 with touch screen and haptic feedback to give best user experience. The electronic display unit 105b may also function as an infotainment unit of the vehicle providing both information and entertainment to the rider. The electronic display unit 105b may be compatible to perform a function based on rider voice command, rider gestures, and provide the rider with navigational guidance, such as, maps, vehicle parameters, such as, speed, distance travelled, distance to the nearest refuelling station, fuel tank level, battery status, mode of functioning of the vehicle, such as, regenerative mode, fuel economy mode, measure of tilt of the vehicle, warnings on expected crash, notifications on calls, messages, social media, etc. The wireless connectivity supporting hardwares 218, such as, Bluetooth hardware facilitates connection of the electronic display unit 105b with the user device 216 like smart helmet, user device pairing, smart access, voice assist functions, Wi-Fi connectivity facilitates wireless updation of the operating system and other softwares of the electronic display unit 105b, the analog display unit 105a, and the visor unit 106. The display controller of the electronic display unit 105b further comprises a System on Chip (SOC) module 221 having a processor, RAM & ROM, PMIC in a single package responsible for performing all the computations, graphics, connectivity, navigation, by the electronic display unit. In an embodiment, the different functions of the SOC module 221 can be implemented using discrete chips.

The secondary sensors 220 of the electronic display unit 105b include an accelerometer, a gyroscope, a compass, an ambient light sensor, a proximity sensor, a temperature sensor, etc. A microcontroller 222 of the display controller is used for interfacing vehicle data to the electronic display unit 105b. The microcontroller 222 is connected to the vehicle control unit 223, such as, other ECUs via CAN interface. The same vehicle data is transferred to the SOC module 221 using serial interface (UART). The vehicle data comprises engine speed, vehicle speed, malfunction, battery voltage, data related to battery management system, motor controller unit, charger, and other body control electronic units, etc. The vehicle data from the electronic display unit 105b is also transmitted to the analog display unit 105a to the meters of the analog display unit 105a. The electronic display unit 105b further comprises drivers for the display interface 219 for driving high performance display interface like TFT, OLED panels of the electronic display unit 105b.

As per another embodiment, the display face 105b of the rotatable display unit 105 may have a docketing cavity for the rider to docket the user device 216 like a mobile phone or a tab etc., which enables charging of the user device 216 and can be additionally configured to operate as the display unit 105b while performing functions like authorisation, app-based diagnostics, vehicle health monitoring, etc.

The controller 204 of the analog display unit 105a is communicatively coupled to the drive unit 209, the visor unit 106, the electronic display unit 105b, the control inputs 217, the sensors 215, and control the operation of the entire dashboard assembly 107 based on the sensor output and the control inputs as will be discussed in the detailed description of FIGS. 3-14B. The controller 204 of the dashboard assembly 107 controls keyless access of the vehicle using the visor unit 106, rotation of the rotatable display unit 105, movement of the visor unit 105 in the opening direction or closing direction, and positioning of the rotatable display unit 105 and the visor unit 106 at a position selected by the rider of the vehicle based on the control inputs 217 and the sensor outputs.

FIG. 3 exemplarily illustrates a schematic diagram of a visor drive unit 206 in the rotatable display unit 105 exemplarily illustrated in FIG. 2. The visor drive unit 206 is operably coupled to the controller 204 of the rotatable display unit 105 and drives the visor unit 106 in the opening direction or the closing direction to at least partially expose or at least partially cover the display faces 105a, 105b of the rotatable display unit 105, respectively. In an embodiment, the visor unit 106 may slide and retract into the handle bar cover 101 completely to expose the rotatable display unit 105. In an embodiment, the visor unit 106 may slide and retract to form a visor in the vehicle driving condition. The visor drive unit 206 includes the motor 302 controlled by the motor controller 301 mechanically engaged with the visor unit 106. The motor 302 may be a stepper motor as exemplarily illustrated or a servo motor. The motor controller 301 is actuated by the controller 204 of the display unit 105a based on the control inputs 217 and/or the sensor output. The motor 302 is actuated by the motor controller 301 and the visor unit rotation mechanism 303 transmits power from the stepper motor 302 to the visor unit 106 or a rack and pinion mechanism for linear actuation of the visor unit 106, etc. The rotation mechanism 303 of the visor drive unit 206 may be a spline, a gear or any driven feature to be driven by the shaft of the motor 302. The visor drive unit 206 further comprises the angle sensor 304, such as, a non-contact type hall sensor, an encoder, etc., that measures the angle of the visor unit 106 in real-time in either the opening direction or the closing direction and provides an angle feedback to the controller 204 of the display unit 105a. Based on the feedback, the controller 204 further actuates the motor controller 301 to move in the opening direction or the closing direction as desired by the rider of the vehicle. The visor unit 106 may be completely opened or closed, or docked at a desired position as selected by the rider using the control inputs 217, or automatically positioned at a predetermined angle by the controller 204 based on the sensor output.

The controller 204 actuates the motor controller 301 using multiple control signals, such as, an enable/disable signal, direction signal, and PWM signal. If the enable/disable (EN/DIS) signal is logic HIGH, then the motor controller 301 is ENABLED to drive the visor unit 106 and if this signal is logic LOW, then the motor controller 301 is DISABLED. The direction signal defines the direction of rotation of the rotor of the motor 302. A logic HIGH input makes the rotor rotate in a clockwise direction and a logic LOW makes the rotor to rotate in anti-clockwise direction. In an embodiment, the clockwise direction of the rotor may move the visor unit 106 in the closing direction and the anticlockwise direction of the rotor may move the visor unit 106 in the opening direction or vice-versa. The PWM signal controls the number of steps of the stepper motor 302. For example, if four PWM pulses are given to the motor controller 301, the rotor will be rotated four steps. The fault status signals are feedback from the motor controller 301 to the controller 204 of the display unit 105a sent using I2C communication. The fault status signals indicate the occurrence of different types of faults in the visor drive unit 206, such as, over load, short circuit, open circuit, low voltage, high voltage. The fault signal reporting to the controller 204 can be implemented using parallel signals also.

FIG. 4 exemplarily illustrates a schematic diagram of a rotatable display drive unit 207 in the rotatable display unit 105 exemplarily illustrated in FIG. 2. The rotatable display drive unit 207 is operably coupled to the controller 204 and drives the rotatable display unit 105 to display the display faces 105a, 105b as selected by the rider or the default preconfigured display face. The rotatable display unit 105 has the display faces 105a, 105b positioned at predetermined angle e.g. 180 degrees to each other requiring the rotation of the rotatable display unit 105 by 180 degrees in a clock wise direction or an anti-clockwise direction to flip to the other display face. The display face 105a, 105b may be selected by the rider using the control inputs 217. The rotatable display drive unit 207 comprises the motor 402 controlled by the motor controller 401 mechanically engaged with the rotatable display unit 105. The motor 402 may be a stepper motor as exemplarily illustrated or a servo motor. The motor 402 is actuated by the motor controller 401 and the rotatable display unit rotation mechanism 403 transmits power from the stepper motor 402 to the rotatable display unit 105 or a rack and pinion mechanism for linear actuation of the rotatable display unit 105, etc. The rotation mechanism 403 of the rotatable display unit 105 may be a spline, a gear or any driven feature to be driven by the shaft of the motor 402. The rotatable display drive unit 207 further comprises an angle sensor 404, such as, a non-contact type hall sensor, an encoder, etc., that measures the angle of the rotatable display unit 105 in real-time while the display unit 105 rotates in the clockwise direction or the anticlockwise direction and provides an angle feedback to the controller 204. Based on the feedback, the controller 204 further actuates the motor controller 401 to move in the clockwise direction or the anti-clockwise direction as desired by the rider of the vehicle. The controller 204 actuates the motor controller 401 using multiple control signals, such as, an enable/disable signal, a direction signal, and a PWM signal. If the enable/disable (EN/DIS) signal is logic HIGH, then the motor controller 401 is ENABLED to drive the visor unit 106 and if this signal is logic LOW, then the motor controller 401 is DISABLED. The direction signal defines the direction of rotation of the rotor of the motor 402. A logic HIGH input makes the rotor rotate in a clockwise direction and a logic LOW makes the rotor to rotate in anti-clockwise direction. The PWM signal controls the number of steps of the stepper motor 402. For example, if four PWM pulses are given to the motor controller 401, the rotor will be rotated four steps. The fault status signals are feedback from the motor controller 401 to the controller 204 of the display unit 105 sent using I2C communication. The fault status signals indicate the occurrence of different types of faults in the rotation display drive unit 207, such as, over load, short circuit, open circuit, low voltage, high voltage. The fault signal reporting to the controller 204 can be implemented using parallel signals also. In an embodiment, the motor controller 301 or the motor controller 201 may control both the visor unit 106 and the rotatable display unit 105 based on one of its inputs, such as, fault signal, EN/DIS, etc.

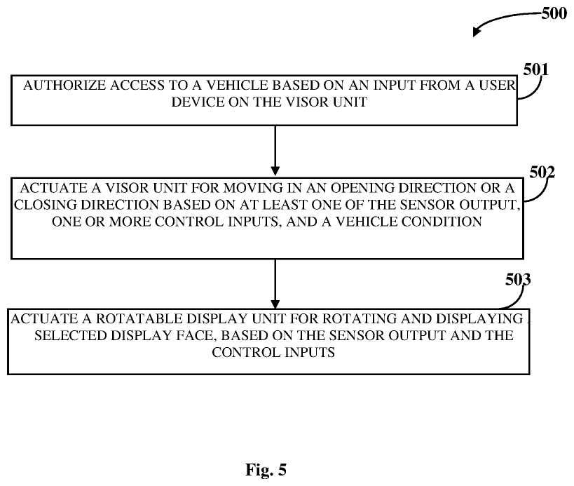

FIG. 5 exemplarily illustrates a flowchart showing a method 500 for controlling operation of the dashboard assembly 107 of the vehicle by the dashboard control system 200 shown in FIG. 2, in communication with the vehicle control unit 223 of the vehicle. At the start of the vehicle, the visor unit 106 may be in the horizontal closed position covering the rotatable display unit 105 underneath and the vehicle is in locked state with ignition OFF. A default display face the rotatable display unit 105, such as, the analog display unit 105a is covered by the visor unit 106 and will be exposed when the visor unit 106 slides and retracts.

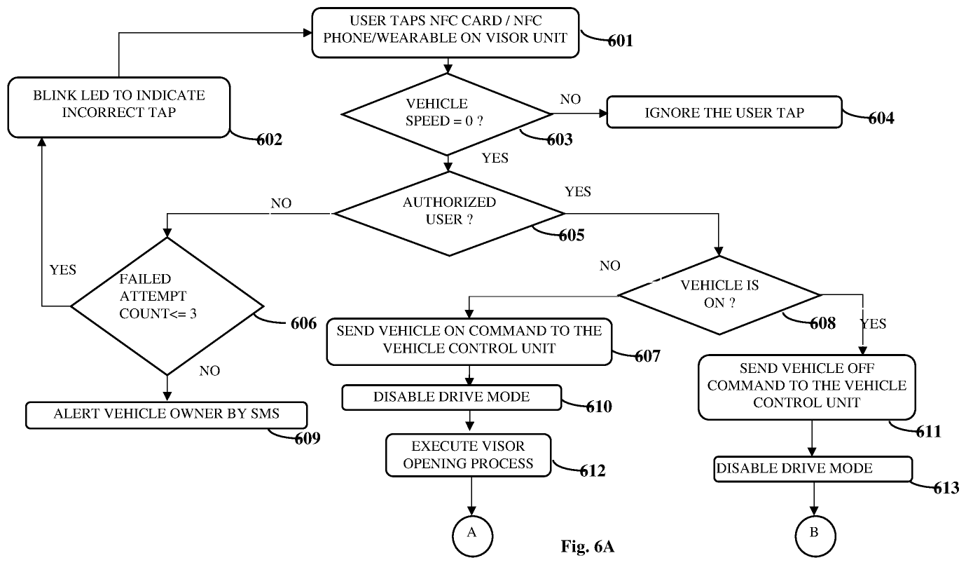

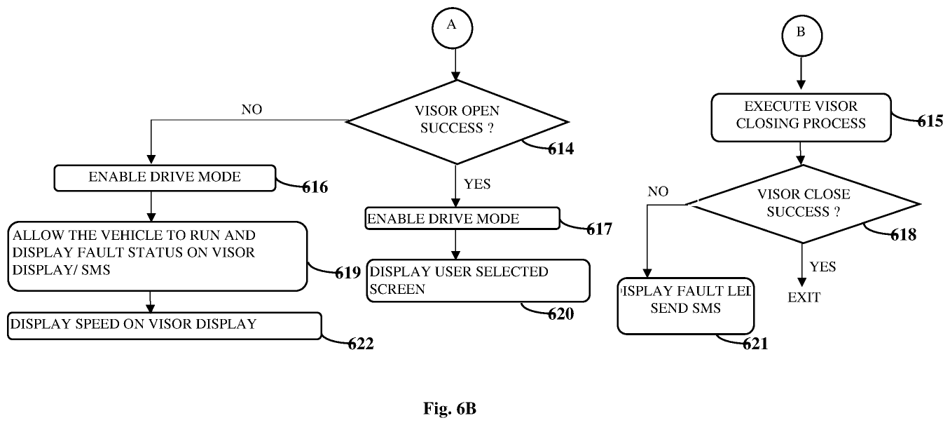

As exemplarily illustrated, at step 501, the controller 204 authorizes access to the vehicle based on an input from the user device 216, such as, the NFC tag, on the visor unit 106. Based on successful keyless authorisation of the vehicle, the visor unit 106 may be allowed to slide and retract to expose the rotatable display unit 105. Using the control inputs, the rider may select the position of the visor unit as desired. At step 502, the controller 204 actuates the visor unit 106 for moving in the opening direction or the closing direction, based on the sensor output, the control inputs 217, and/or a vehicle condition. The rider chooses the display face 105a, 105b of the rotatable display unit 105 using the control inputs 217 that the rider desires to view, based on his/her preference, comfort. At step 503, the controller 204 actuates the rotatable display unit 105 for rotating and displaying a selected display face, based on the sensor output and a selection of the control inputs. Each of these steps of the method is described in the detailed description of FIGS. 6A-14B.

FIGS. 6A-6B exemplarily illustrate a flowchart comprising steps for authorization of access of the vehicle by the controller 204. At step 601, the rider taps the user device 216, for example, a NFC tag, a NFC enabled phone, a Bluetooth device, the wearable device, etc., on the visor unit 106 to lock or unlock the vehicle. After unlocking the vehicle, to use the vehicle, the visor unit 106 moves in the opening direction to expose the display face 105a/105b. After locking the vehicle, the visor unit 106 moves in the closing direction to completely cover the rotational display unit 105. While driving the vehicle, the visor unit 106 can be positioned at different angles based on the comfort of the rider, either manually or automatically. To adjust the position of the visor unit 106, the visor unit 106 may be moved in either the opening direction or the closing direction. The opening direction may be movement of the visor unit 106 towards the rider of the vehicle and the closing direction may be movement of the visor unit 106 away from the rider of the vehicle.

The front end IC 203, such as, the NFC controller in co-ordination with the controller 204 of the rotatable display unit 105 authorizes the rider to access the vehicle. The controller 204 authorizes the rider based on the vehicle condition. The vehicle condition may be one of a vehicle ignition ON condition, a vehicle ignition OFF condition, a vehicle stationary condition, and a vehicle running condition. The vehicle ignition ON condition is a condition where the ignition of the vehicle is switched ON, irrespective of the speed of the vehicle. The vehicle ignition OFF condition is a condition where the ignition is switched OFF. The vehicle stationary condition indicates the speed of the vehicle is 0 and the vehicle running condition indicates the vehicle is running at or above a predetermined speed, V1. At step 603, the front end IC 203 in the rotatable display unit 105 determines if the vehicle condition is stationary. When the rider places a NFC card or a phone near the NFC antenna area in the visor unit 106, the NFC controller front end IC 203 checks with the main microcontroller 204 whether the vehicle is stationary or not. At step 604, if the vehicle is not stationary, the tap of the NFC tag on the visor unit 106 is ignored. If the vehicle is stationary, at step 605, the NFC controller 203 will read the tag and check for authorization of the rider to access the vehicle. The authorization of the rider may be successful or unsuccessful. If the NFC tag detect is not successful at step 605, then the NFC controller 203 in co-ordination with the controller 204 indicates the fault in the NFC tag reading and display a message or blink the LEDs of the secondary display unit 202 of the visor unit 106 to tap the NFC tag or user device 216 again as shown in step 602. At step 606, the NFC controller 203 also determines the number of unsuccessful attempts of authorization. The controller 204 allows for a predetermined number of attempts and then rider or the owner of the vehicle will be notified about the failed attempts by using SMS, user application notification, or any other social media means as shown in step 609.

If the tap of the Valid NFC tag is detected at step 605 by the NFC controller 203, then the controller 204 of the rotatable display unit 105 sends commands to the vehicle control unit 223 to determine the vehicle condition and a drive mode of the vehicle as shown in step 608. The drive mode of the vehicle may be a power mode, an economy mode, a sports mode, a snow mode, a comfort mode, or any customised mode for driving the vehicle with fuel efficiency, while providing comfort to the rider. If the vehicle condition is ignition ON condition, at step 611, the vehicle control unit 223 changes the vehicle condition to vehicle ignition OFF condition. In the vehicle ignition OFF condition, the vehicle control unit 223 and other control units in the vehicle are turned OFF. The vehicle control unit 223 disables the drive mode of the vehicle prior to actuating the visor unit 106 for moving in the opening direction or the closing direction. At step 613, the vehicle control unit 223 disables the drive mode and waits for an acknowledgement from other ECU's about the drive disabling. After receiving the acknowledgement, at step 615, the controller 204 actuates the visor unit 106 for moving in the closing direction based on the vehicle ignition OFF condition. If at step 608, the vehicle condition is ignition OFF condition, then at step 607, the vehicle control unit 223 changes the vehicle condition to vehicle ignition ON condition. In the vehicle ignition ON condition, the vehicle control unit 223 and the other control units in the vehicle are turned ON. At step 610, the vehicle control unit 223 disables the drive mode. After the acknowledgement from other ECU's about the disabling of the drive mode, at step 612, the controller 204 actuates the visor unit 106 for moving in the opening direction based on the vehicle ignition ON condition.

At step 618, the controller 204 determines if at least partial movement of the visor unit 106 in the closing direction is successful. If the visor drive unit 206 confirms that the closing of the visor unit 106 is successful, the process of keyless access to the vehicle to lock the vehicle is complete. In case closing process of the visor unit 106 closing process fails, the controller 204 will lock the rotatable display unit 105 in the same position and displays the fault using LED's and also informs the user by SMS, user application notification as shown in step 621.

At step 614, the controller 204 determines if at least partial movement of the visor unit 106 in the opening direction is successful. If the visor drive unit 206 confirms that the visor unit 106 opening is successful, the drive mode of the vehicle is enabled by the vehicle control unit 223 as shown in step 617 and the display face 105a/105b of the rotatable display unit 105 underneath the visor unit 106 is shown at step 620. The process of keyless access to the vehicle is complete and the vehicle is ready to be used. In case of visor unit 106 opening process fails, the vehicle control unit 223 enables the drive mode of the vehicle as shown in step 616 and the controller 204 displays vehicle authorization status information and the vehicle status information, such as, the speed of the vehicle, message on fault in opening of the visor unit 106, etc., in the secondary display unit 202 as shown in steps 619 and 622, thereby enabling user to use the vehicle even in case of a fault and reach nearest service or repair destination.

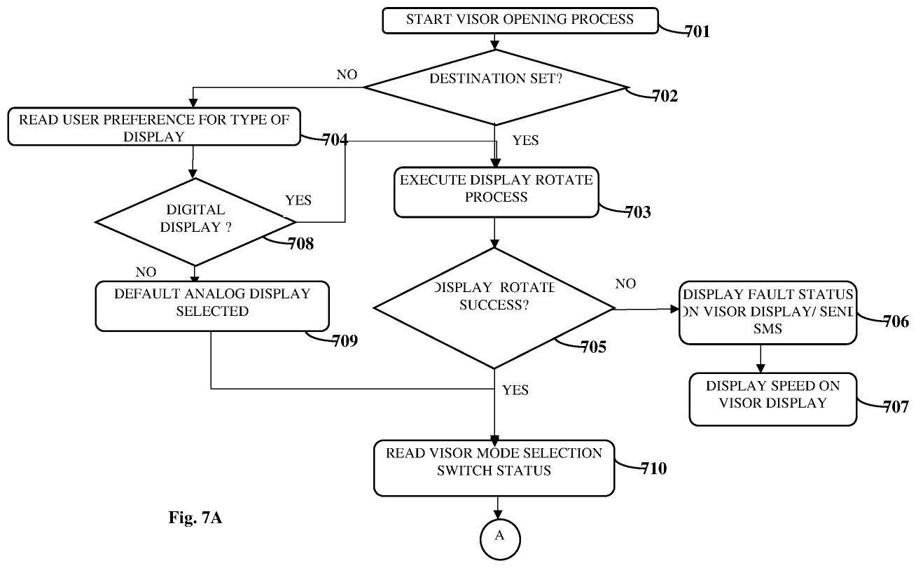

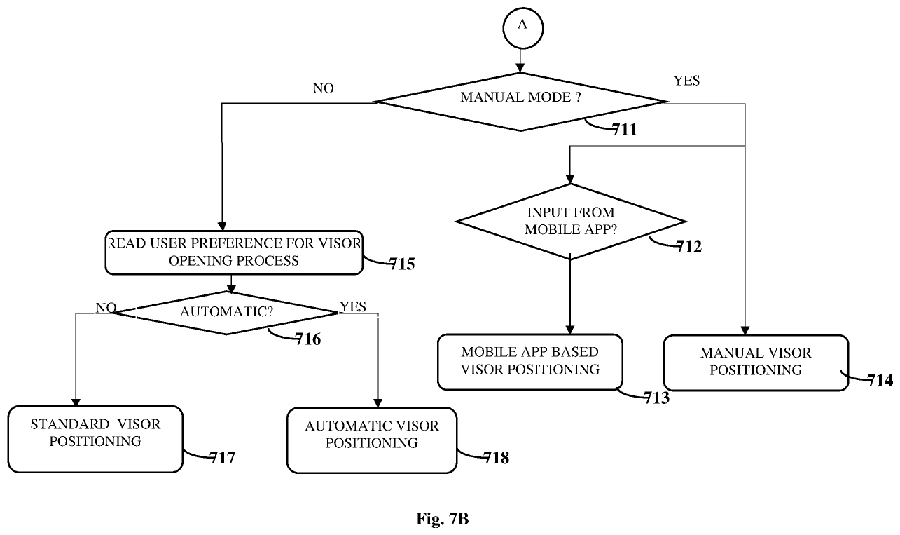

FIGS. 7A-7B exemplarily illustrate a flowchart comprising steps for actuation of the visor unit 106 to at least partially move in the opening direction by the controller 204. The visor unit 106 may be in completely closed position at the start of the vehicle or may be in a partially closed position. The visor unit 106 may have to be completely opened or may have to be moved to a position as desired by the rider or automatically by the controller 204. At step 701, at the start of the visor unit 106 opening process, the controller 204 in co-ordination with the vehicle control unit 223 checks if a destination for navigating the vehicle is set in the user application 216a or the electronic display unit 105b, etc., as shown in step 702. The controller 204 actuates the visor unit 106 to move in the closing direction, prior to actuation of the rotatable display unit 105 for rotating and displaying a selected display face. Prior to actuating the visor unit 106 to move in the closing direction, the controller 204 determines the type of the display face 105a/105b of the rotatable display unit 105 facing the rider of the vehicle. Since the visor unit 106 is in the closed position, at step 703, the controller 204 executes rotation of the rotatable display unit 105. The controller 204 determines from the angle sensor of the rotatable display drive unit 207, whether the rotation of the display unit 105 is successful at step 705. If the rotation of the display unit 105 is unsuccessful and the rotatable display unit 105 is stuck at a wrong angle, then the controller 204 displays the speed of the vehicle and the fault status of the rotatable display unit 105 on the secondary display unit 202 of the visor unit 106 as shown in steps 706 and 707.

If the destination is not set in the user application 216a or the electronic display unit 105b, the controller 204 allows the rotatable display unit 105 to rotate and display the electronic display unit 105b to set a destination. To do this, at step 704, the controller 204 reads user preference for the type of display face 105a/105b of the rotatable display unit 105, according to his/her user profile in the user application 216a. If the display face is selected or set by the rider to be electronic display unit 105b, the controller 204 executes rotation of the rotatable display unit 105 as shown in step 708. Further, if the display face is not selected by the rider, the default display face of the rotatable display unit 105 is preconfigured to be the analog display unit 105a as shown in step 709. In an embodiment, the display face may also be rotated by the controller 204, after the opening of the visor unit 106.

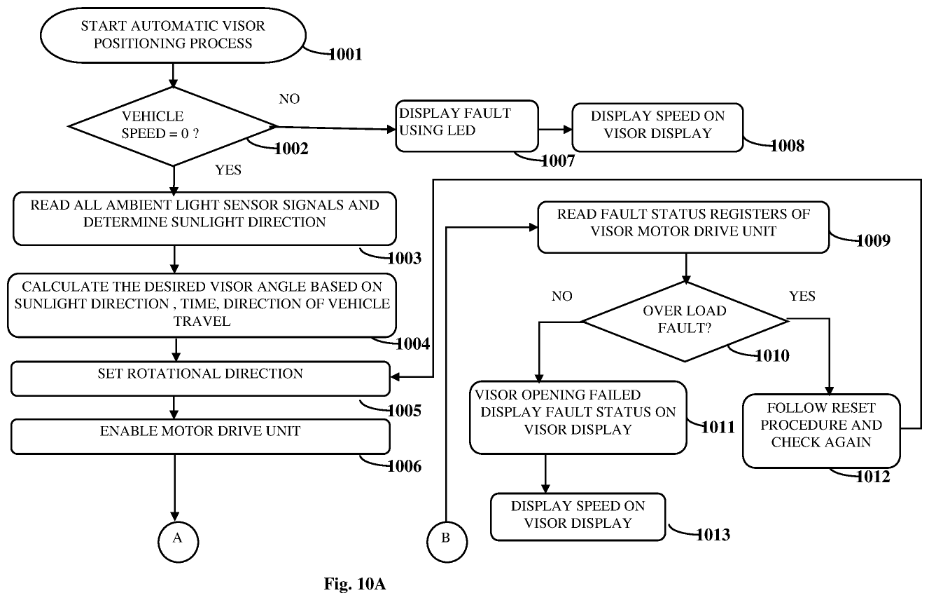

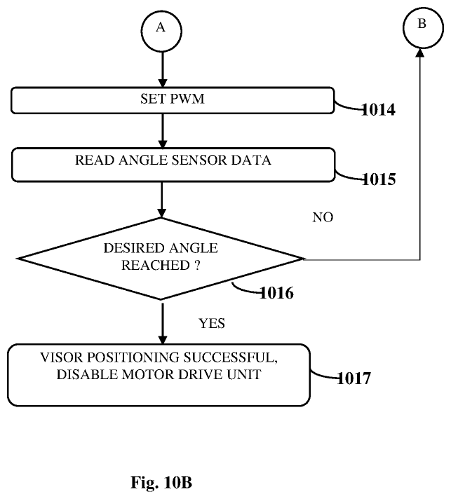

If the rotation of the display unit is successful, then in step 710 the controller 204 checks for the control inputs 217 that indicate the mode of operation of the visor unit 106. The preferred modes of positioning and movement of the visor unit 106 may also be preconfigured in the user profile of the user application 216a by the rider. The different modes of the movement and positioning of the visor unit 106 in the opening direction based on the control inputs 217 and the sensor output are manual mode, standard mode, automatic mode, and user application based. In the manual mode of movement of the visor unit 106, the angle of positioning the visor unit 106 is provided by means of control inputs 217, such as, the switches 104 on the handle bar cover 101, the dashboard assembly 107, etc. In the user application based positioning of the visor unit 106, the angle of positioning the visor unit 106 is provide by means of control inputs 217 in the user application 216a on the user device 216, such as, gestures and voice commands. In the standard mode of movement and positioning of the visor unit 106, the angle of positioning the visor unit 106 is set to the factory settings of the visor unit 106 and the visor unit 106 is actuated to be positioned at that angle. In the automatic mode of movement and positioning of the visor unit 106, the angle of positioning the visor unit 106 is determined by the controller 204 based on the sensor output as will be described in the FIGS. 10A-10B.

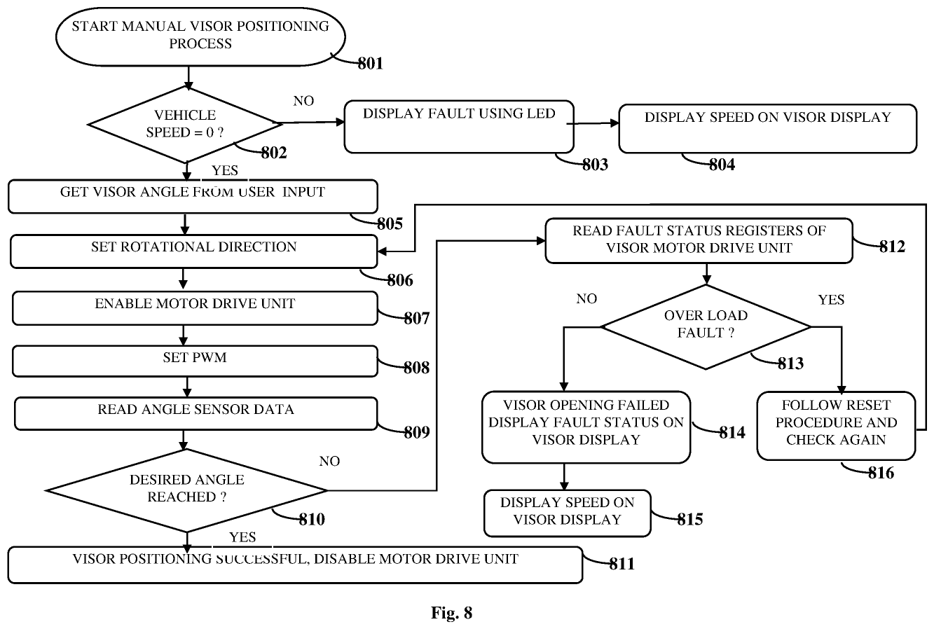

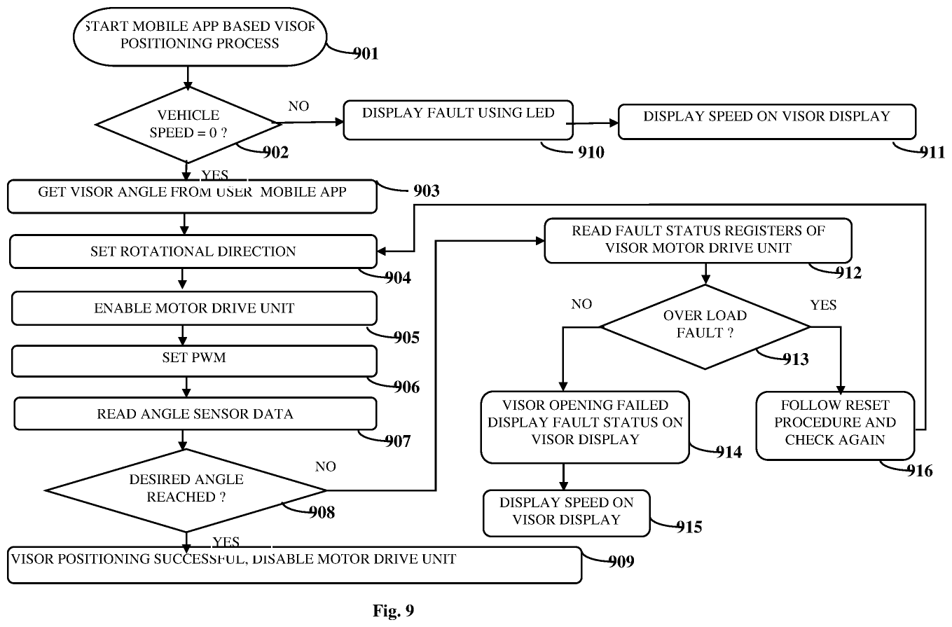

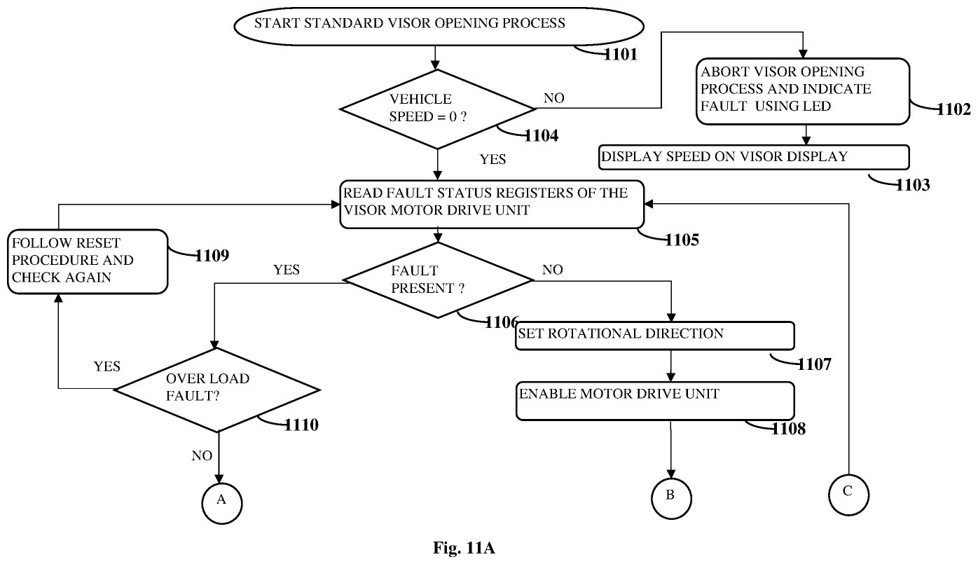

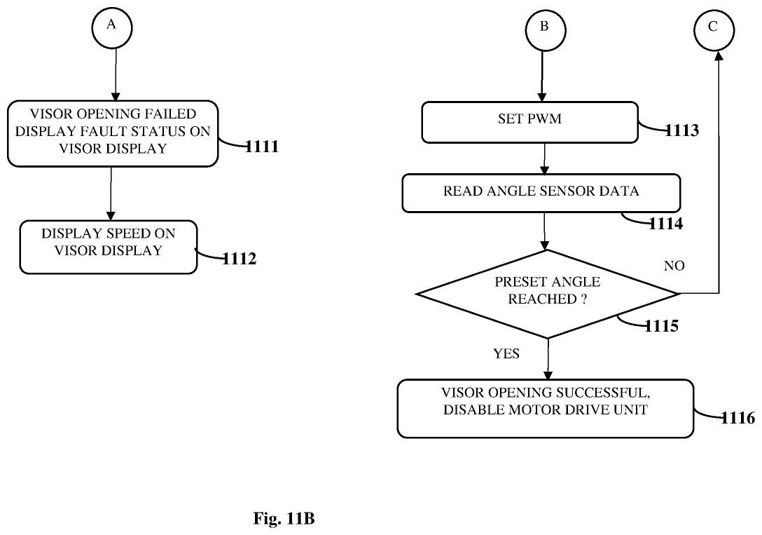

At step 711, the controller 204 determines if manual mode of positioning the visor unit is selected in the control inputs 217. If manual mode is selected, the controller 204 proceeds to perform manual mode of positioning the visor unit 106 as shown in step 714 and described in FIG. 8. If under manual mode of positioning and movement of the visor unit 106, the controller 204 determines at step 712 that the control input is from the user application 216a, then at step 713, the controller 204 performs user application based positioning of the visor unit 106 described in FIG. 9. If manual mode is not selected, the controller 204 reads user profile of the user application 216a to determine the user preferences at step 715. The controller 204 then determines, at step 716, whether automatic mode of visor unit 106 positioning is selected. If automatic mode of movement and positioning of the visor unit 106 is selected, at step 718, the controller 204 performs automatic mode of positioning the visor unit 106 described in FIG. 10A-10B. If standard mode of movement and positioning of the visor unit 106 is selected, at step 717 the controller 204 performs standard mode of positioning the visor unit 106 described in FIG. 11A-11B.

FIG. 8 exemplarily illustrates a flowchart comprising steps for movement of the visor unit 106 in the opening direction and positioning of the visor unit 106 in the manual mode by the controller 204. At step 801, in the manual mode of positioning the visor unit 106, the controller 204 determines the vehicle speed to be zero of the vehicle to be in stationary condition as shown in step 802. If the vehicle is not in stationary condition, the controller 204 displays vehicle status information, such as, the speed of the vehicle, message on fault in opening of the visor unit 106, etc., in the secondary display unit 202 as shown in steps 803 and 804. If the vehicle is in stationary condition, at step 805 the controller 204 receives a selection of an angle for positioning the visor unit 106, that is, the visor angle from the user by means of the control inputs 217. The rider can input the visor angle as a touch input on the electronic display unit 105b, as an input in the switches 104 on the handle bar cover 101, the dashboard assembly 107, etc. The rotational direction of the motor 302 of the visor drive unit 206 may be preconfigured. Based on the angle selected by the rider, the controller 204 at step 806 sets the rotational direction of the motor controller 301 of the visor drive unit 206. At step 807, the controller 204 also generates the ENABLE signal of the motor controller 301 of the visor drive unit. Further at step 808, the controller 204 sets the PWM steps input to the motor controller 301 for the motor 302 to rotate, based on the selected angle. The controller 204, at step 809, reads the senor output from the angle sensor 304 in real-time and at step 810 determines if the selected angle is reached by the visor unit 106 on rotation of the motor 302. If the selected angle is reached as determined by the angle sensor 304, at step 811 the controller 204 determines that the visor unit 106 positioning at the selected angle is successful and the controller 204 disables the visor drive unit 206.

If the desired angle to position the visor unit 106 is not reached, the controller 204 reads fault status registers of the visor drive unit 206 at step 812. The controller 204 at step 813 determines if an overload fault as occurred in the visor unit 106. If an overload fault has occurred, the controller 204 resets the registers and the steps 806-810 are repeated as shown in step 816. If overload fault has not occurred, the controller 204 displays vehicle status information, such as, the speed of the vehicle, message on fault in opening of the visor unit 106, etc., in the secondary display unit 202 as shown in steps 814 and 815.

FIG. 9 exemplarily illustrate a flowchart comprising steps for movement of the visor unit 106 in the opening direction and positioning of the visor unit 106 based on the user application 216a, by the controller 204. At step 901, in the user application based positioning of the visor unit 106, the controller 204 determines the vehicle speed to be zero of the vehicle to be in stationary condition as shown in step 902. If the vehicle is not in stationary condition, the controller 204 displays vehicle status information, such as, the speed of the vehicle, message on fault in opening of the visor unit 106, etc., in the secondary display unit 202 as shown in steps 910, 911. If the vehicle is in stationary condition, at step 903, the controller 204 receives the visor angle from the user by means of the control inputs, such as, the user device 216. The rider can input the visor angle as a touch input in the user application 216a, as a gesture in the wearable device, as voice input in the user application 216a or the wearable device. In an embodiment, the visor angle may be set in the user profile of the user application 216a on the user device 216. The rotational direction of the motor 302 of the visor drive unit 206 may be preconfigured in the user profile in the user application 216a. Based on the angle selected by the rider, the controller 204 at step 904 sets the rotational direction of the motor controller 301 of the visor drive unit 206. At step 905, the controller 204 also generates the ENABLE signal of the motor controller 301 of the visor drive unit 206. Further at step 906, the controller 204 sets the PWM steps to the motor controller 301 for the motor 302 to rotate, based on the selected angle. The controller 204 at step 907 reads the sensor output from the angle sensor 304 in real-time and at step 908 determines if the selected angle is reached by the visor unit 106 on rotation of the motor 302. If the selected angle is reached, at step 909 the controller 204 determines that the visor unit 106 positioning at the selected angle is successful and the controller 204 disables the visor drive unit 206.

If the desired angle to position the visor unit 106 is not reached, the controller 204 reads the fault status registers of the visor drive unit 106 at step 912. The controller 204 at step 913 determines if an overload fault as occurred in the visor unit 106. If an overload fault has occurred, the controller 204 resets the registers and the steps 904-908 are repeated as shown in step 916. If overload fault has not occurred, the controller 204 displays vehicle status information, such as, the speed of the vehicle, message on fault in opening of the visor unit 106, etc., in the secondary display unit 202 as shown in steps 914, 915.

FIGS. 10A-10B exemplarily illustrate a flowchart comprising steps for movement of the visor unit 106 in the opening direction and positioning of the visor unit 106 in the automatic mode, by the controller 204. At step 1001, in the automatic mode of positioning the visor unit 106, the controller 204 determines the vehicle speed to be zero of the vehicle to be in stationary condition as shown in step 1002. If the vehicle is not in stationary condition, the controller 204 displays vehicle status information, such as, the speed of the vehicle, message on fault in opening of the visor unit 106, etc., in the secondary display unit 202 as shown in steps 1007, 1008. If the vehicle is in stationary condition, at step 1003 the controller 204 reads the sensor output from the ambient light sensors and the almanac information, such as, date, day, and time of travel of the vehicle, sunrise time, sunset time, weather conditions, etc., through the user device 216 to determine the sunlight direction. Based on the sensor output and the almanac information, the controller 204 computes the desired angle to position the visor unit 106 for the comfort of the rider at step 1004. The rotational direction may be preconfigured in the user profile in the user application 216a. Based on the angle computed by the controller 204, the controller 204 at step 1005 sets the rotational direction of the motor controller 301 of the visor drive unit 206. At step 1006, the controller 204 also generates the ENABLE signal of the motor controller 301 of the visor drive unit 206. Further at step 1014, the controller 204 sets the PWM steps to the motor controller 301 for the motor 302 to rotate, based on the computed angle. The controller 204 at step 1015 reads the senor output from the angle sensor 304 in real time and at step 1016 determines if the computed angle is reached by the visor unit 106 on rotation of the motor 302. If the computed angle is reached, at step 1017 the controller 204 determines that the visor unit 106 positioning at the computed angle is successful and the controller 204 disables the visor drive unit 206.

If the desired angle to position the visor unit 106 is not reached, the controller 204 reads the fault status registers of the visor drive unit 206 at step 1009. The controller 204 at step 1010 determines if an overload fault as occurred in the visor unit 106. If overload fault has occurred, the controller 204 resets the register at step 1012 and the steps 1004-1016 are repeated. If overload fault has not occurred, the controller 204 displays vehicle status information, such as, the speed of the vehicle, message on fault in opening of the visor unit 106, etc., in the secondary display unit 202 as shown in steps 1011, 1013.

FIGS. 11A-11B exemplarily illustrate a flowchart comprising steps for movement of the visor unit 106 in the opening direction and positioning of the visor unit 106 in the standard mode, by the controller 204. At step 1101, in the standard mode of positioning the visor unit 106, the controller 204 determines the vehicle speed to be zero of the vehicle to be in stationary condition as shown in step 1104. If the vehicle is not in stationary condition, the controller 204 displays vehicle status information, such as, the speed of the vehicle, message on fault in opening of the visor unit 106, etc., in the secondary display unit 202 as shown in steps 1102, 1103. If the vehicle is in stationary condition, at step 1105 the controller 204 reads the fault status registers of the visor drive unit 206. The controller 204 at step 1106 determines if a fault has occurred. At step 1110, the controller 204 determines whether the fault occurred is an overload fault. If overload fault has occurred, the controller 204 resets the register at step 1109 and the step 1105 is repeated. If overload fault has not occurred, the controller 204 displays vehicle status information, such as, the speed of the vehicle, message on fault in opening of the visor unit 106, etc., in the secondary display unit 202 as shown in steps 1111, 1112.

If at step 1106, no fault has occurred, the angle of positioning the visor unit 106 is set to the factory setting value. Based on the angle, the controller 204 at step 1107 sets the rotational direction of the motor controller 301 of the visor drive unit 206. At step 1108, the controller 204 also generates the ENABLE signal of the motor controller 301 of the visor drive unit 206. Further at step 1113, the controller 204 sets the PWM steps to the motor controller 301 for the motor 302 to rotate, based on the preset angle. The controller 204 at step 1114 reads the sensor output from the angle sensor 304 in real-time and at step 1115 determines if the preset angle is reached by the visor unit 106 on rotation of the motor 302. If the preset angle is reached, at step 1116 the controller 204 determines that the visor unit 106 positioning at the preset angle is successful and the controller 204 disables the visor drive unit 206. If preset angle is not reached at step 1115, then step 1105 onwards is repeated.

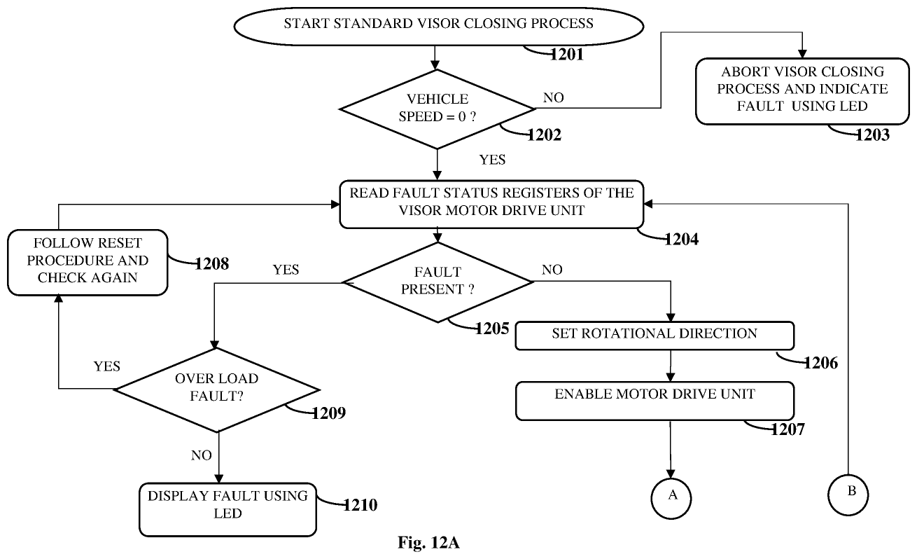

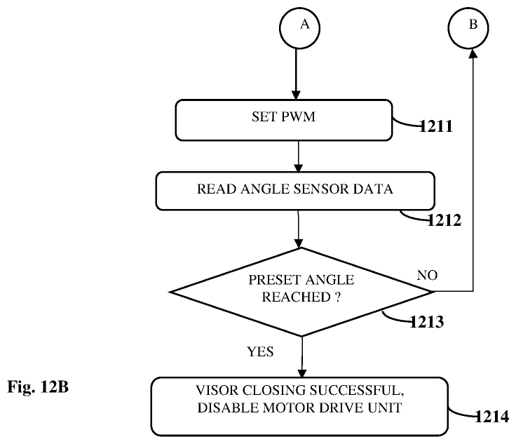

FIGS. 12A-12B exemplarily illustrate a flowchart comprising steps for actuation of the visor unit 106 to at least partially move in the closing direction by the controller 204. At step 1201, in the standard mode of moving the visor unit 106 in the closing direction, the controller 204 determines the vehicle speed to be zero or the vehicle is in stationary condition as shown in step 1202. If the vehicle is not in stationary condition, the controller 204 aborts the visor unit closing process and displays visor fault information, such as, message on fault in closing of the visor unit 106, etc., in the secondary display unit 202 as shown in step 1203. If the vehicle is in stationary condition, at step 1204 the controller 204 reads the fault status registers of the visor drive unit 206. The controller 204 at step 1205 determines if a fault has occurred. At step 1209, the controller 204 determines whether the fault occurred is an overload fault. If overload fault has occurred, the controller 204 resets the register at step 1208 and the step 1204 is repeated. If overload fault has not occurred, the controller 204 displays visor status information, such as, the message on fault in closing of the visor unit 106, etc., in the secondary display unit 202 as shown in step 1210.

If at step 1205, a fault has not occurred, the angle of positioning the visor unit 106 is set to the factory setting value for closing the visor unit. Based on the angle, the controller 204 at step 1206 sets the rotational direction of the motor controller 301 of the visor drive unit 206. At step 1207, the controller 204 also generates the ENABLE signal of the motor controller 301 of the visor drive unit 206. Further at step 1211, the controller 204 sets the PWM steps to the motor controller 301 for the motor 302 to rotate, based on the preset angle. The controller 204 at step 1212 reads the sensor output from the angle sensor in real time and at step 1213 determines if the preset angle is reached by the visor unit 106 on rotation of the motor 302. If the preset angle is reached as indicated by the sensor output of the angle sensor 304, at step 1214 the controller 204 determines that the visor unit 106 positioning at the preset angle is successful and the controller 204 disables the visor drive unit. While moving the visor unit 106 in the closing direction, other modes of positioning the visor unit 106, such as, automatic positioning, manual positioning and user application based positioning similar to the ones in the opening process are possible. If preset angle is not reached at step 1213, then step 1204 onwards is repeated.

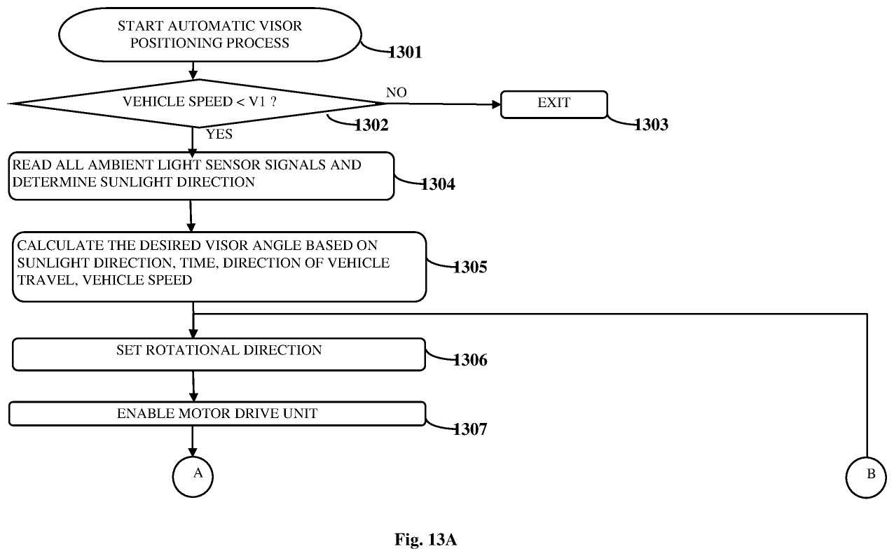

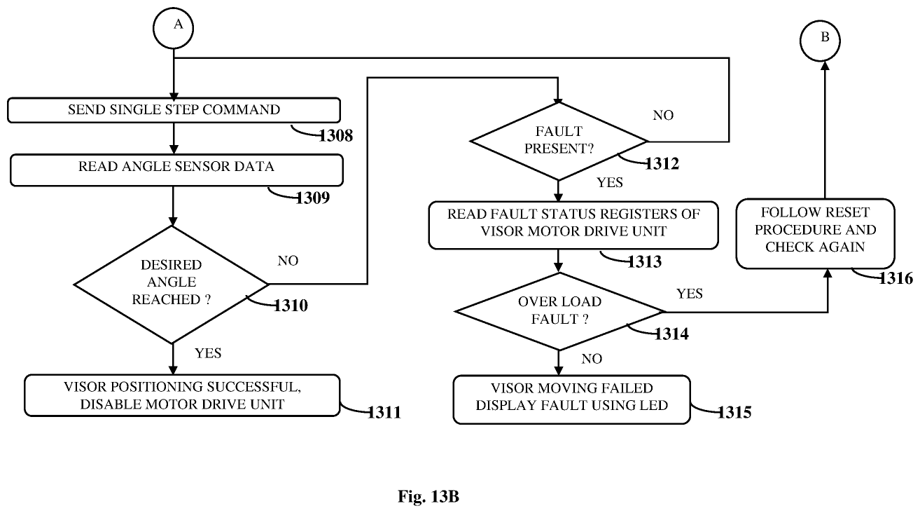

FIGS. 13A-13B exemplarily illustrate a flowchart comprising steps for actuation of the visor unit 106 to at least partially move in the opening direction by the controller 204, in the automatic mode, by the controller 204, in the running condition of the vehicle. In the running condition of the vehicle, the vehicle is running at speed lower than a predetermined speed V1. At step 1301, in the automatic mode of positioning the visor unit 106, the controller 204 determines the vehicle speed is less than V1 as shown in step 1302. If the vehicle speed is not less than V1, the controller 204 exits from visor positioning process at step 1303. If the vehicle is running condition, at step 1304 the controller 204 reads the sensor output from the ambient light sensors and the almanac information, such as, date, day, and time of travel of the vehicle, sunrise time, sunset time, weather conditions, etc., through the user device 216 to determine the sunlight direction. Based on the sensor output and the almanac information, the controller 204 computes the desired angle to position the visor unit 106 for the comfort of the rider at step 1305. The rotational direction may be preconfigured in the user profile in the user application 216a. Based on the angle computed by the controller 204, the controller 204 at step 1306 sets the rotational direction of the motor controller 301 of the visor drive unit 206. At step 1307, the controller 204 also generates the ENABLE signal of the motor controller 301 of the visor drive unit 206. Further at step 1308 the controller 204 sets the PWM steps to the motor controller 301 for the motor 302 to rotate, based on the computed angle. The controller 204 at step 1309 reads the sensor output from the angle sensor 304 in real time and at step 1310 determines if the computed angle is reached by the visor unit 106 on rotation of the motor 302. If the computed angle is reached, at step 1310 the controller 204 determines that the visor unit 106 positioning at the computed angle is successful and the controller 204 disables the visor drive unit 206.

If the desired angle to position the visor unit 106 is not reached, the controller determines if a fault has occurred at step 1312. If fault has not occurred, the steps 1307-1310 are repeated. If fault has occurred, at step 1313, the controller 204 reads the fault status registers of the visor drive unit 206. The controller 204 at step 1314 determines if an overload fault as occurred in the visor unit 106. If overload fault has occurred, the controller 204 resets the register at step 1316 and the steps 1306-1310 are repeated. If overload fault has not occurred, the controller 204 displays vehicle status information, such as, the speed of the vehicle, message on fault in opening of the visor unit 106, etc., in the secondary display unit 202 as shown in step 1315.

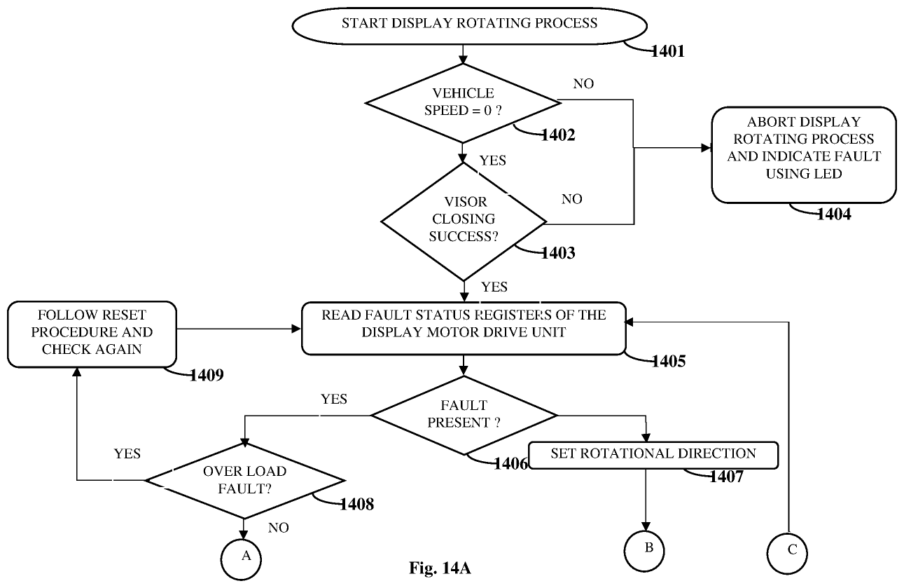

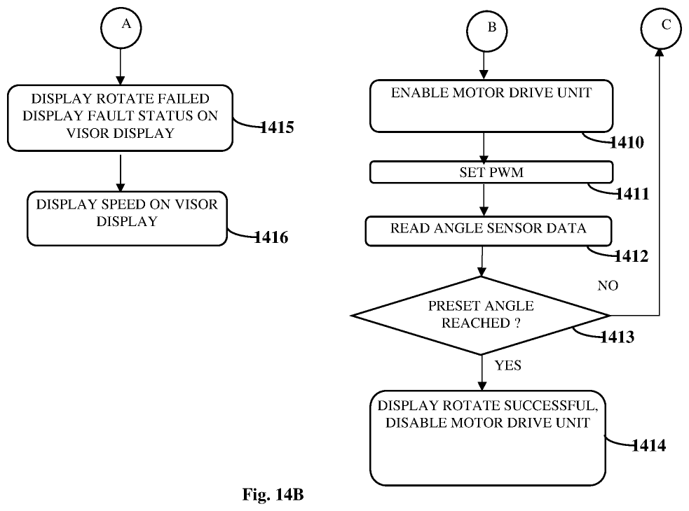

FIGS. 14A-14B exemplarily illustrate a flowchart comprising steps for actuation of the rotatable display unit 105 to rotate and display a selected display face 105a/105b, by the controller 204. At step 1401, in the standard mode of positioning the visor unit 106, the controller 204 determines the vehicle speed to be zero of the vehicle to be in stationary condition as shown in step 1402. If the vehicle is not in stationary condition, the controller 204 aborts the display unit 105 rotating process and displays vehicle status information, such as, the speed of the vehicle, message on fault in rotating the display unit 105, etc., in the secondary display unit 202 as shown in step 1404. Prior to the actuation of the rotatable display unit 105 for rotating and displaying the selected display face 105a/105b, the controller 204 ensures the visor unit 106 is in completely closed position. If the visor unit 106 does not cover the rotatable display unit 105 completely, the controller 204 actuates the visor unit 106 to move in the closing direction.

If the vehicle is in stationary condition, at step 1403, the controller 204 determines if the visor unit 106 in completely closed position. If the visor unit 106 is not completely closed as determined by the angle sensor of the visor drive unit 206, the controller 204 aborts the display rotation process and indicates the fault in the secondary display unit 202 as shown in step 1404. At step 1405, the controller 204 reads the fault status registers of the rotatable display drive unit 207. The controller 204 at step 1406 determines if a fault has occurred. If fault has occurred, the controller 204 determines if an overload fault as occurred in the rotatable display drive unit 207 at step 1408. If overload fault has occurred, at step 1409, the controller 204 resets the register and the step 1405 is repeated. If overload fault has not occurred, the controller 204 displays vehicle status information, such as, the speed of the vehicle, message on fault in rotation of the rotatable display unit 105, etc., in the secondary display unit 204 as shown in steps 1415, 1416.

If at step 1406, a fault has not occurred, a selection of the display face is received from the control inputs by the controller 204. The controller 204 determines the display face already being displayed and determines the angle of rotation to position the selected display face. Based on the angle, the controller 204 at step 1407 sets the rotational direction of the motor controller 401 of the rotatable display drive unit 207. At step 1410, the controller 204 also generates the ENABLE signal of the motor controller 401 of the rotatable display drive unit 207. Further at step 1411, the controller 204 sets the PWM steps to the motor controller 401 for the motor 402 to rotate, based on the determined angle. The controller 204 at step 1412 reads the sensor output from the angle sensor 404 in real time and at step 1413 determines if the computed angle of rotation of the rotatable display unit 105 to display the selected display face. If the selected angle is reached, at step 1414 the controller 204 determines that the rotatable display unit 105 positioning with the selected display face is successful and the controller 204 disables the rotatable display drive unit 207. If at step 1413, the computed angle of rotation of the rotatable display unit 207 is not reached, the step 1405 is repeated.

The embodiments of the dashboard control system with the rotatable display unit and the visor unit provides a technical advancement in the field of design of dashboards in vehicles as follows: The visor unit covers or exposes the display faces of the rotatable display unit to sunlight. The display faces are thus protected from continuous exposure to sunlight, even in the vehicle parked condition. The visor unit also protects glare from occurring on the display faces in the line of sight of the rider, providing convenience in readability and accessibility of the rotatably adjustable display unit. The visor unit being closed in a user chosen closed condition e.g. when parked, protects the display faces from dust accumulation and rain. The visor unit also functions as a windshield in the retracted position, thereby enhancing the aero dynamics of the vehicle and protecting the display faces from any striking particles, such as, insects, gravel, etc. The visor unit comprises a contactless card, such as, the NFC card that allows keyless contact-less authorisation of the vehicle, providing convenience to the rider. The secondary display unit on a top surface of the visor unit aids in normal functioning of the vehicle, in case the visor unit malfunctions thereby achieving a failsafe mode for the vehicle. This aids in taking the vehicle for servicing without any hindrance, by driving the vehicle a minimal distance without the visor unit being opened. Also, the secondary display unit is aesthetically appealing and ergonomically placed to display the status of the vehicle, such as, the speed of the vehicle, the vehicle ON/OFF status, etc. The secondary display unit can also be used for branding of the vehicle, with the logo on it. Also, the NFC card is ergonomically placed in the visor unit to be within the reach of variety of riders. The actuation of the visor unit by different means requires no manual interference from the rider causing no distraction to the rider in the course of ride. Also, the means for engaging the visor unit with the handle bar cover is simple and easy to manufacture with sufficient tolerance to accommodate production variance.

The display faces of the rotatable display unit are flush with the top surface of the handle bar cover, making the dashboard assembly aesthetically appealing and ergonomically positioned to interact by the rider. The rotatable display unit is rotatable that facilitates the positioning of the display faces as required by the user and selecting the display face as per the preference of the rider. The rotation of the rotatable display unit is performed only when the visor unit is completely closed, thereby not disturbing the rider and making the dashboard assembly appealing to the rider. Also, the movement of the rotatable display unit and the visor unit are performed only when the vehicle is stationary or running at a minimum speed, thereby not distracting the attention of the rider. The display faces may be slightly tilted to prevent glare that hinders visibility and readability of the display faces. The position of the rotatable display unit may be decided by the rider of the vehicle and actuated by using a plurality of means, without requiring manual interference. The rotatable display unit is modular and customisable, as per the requirement of the different category of riders, such as young and old. The option of one of the display faces being an infotainment unit addresses the need for entertainment of the rider and appealing user interface for the rider e.g. in case of prolonged parking. The rotatable display unit when hidden or in closed mode in the parking conditions of the vehicle also is theft deterrent.

The drive mechanisms for both the rotatable display unit and the visor unit assembly are all modular, making the assembly, maintenance, and servicing of the assemblies less cumbersome and less time consuming. The display faces and the visor unit by means of the stepper motor may be positioned at different desired angles, without any manual intervention. Since the mechanisms of the rotatable display unit and the visor unit are modular, they may be retrofit or custom fit in existing vehicles, to address different needs. Also, the mechanisms for the rotatable display unit and the visor unit assembly for mechanical actuation of the display faces and also the visor unit may be rack and pinion, belts, chains or pulleys, etc. Also, the faults due to the jamming of the visor unit, the rotatable display unit, short circuit/low voltage/high voltage in the visor drive unit and the rotatable display drive unit are displayed on the secondary display unit, in the user application, in the electronic display unit, etc., and this alerts the rider to address these problems as soon as possible.

The dashboard assembly disclosed may be implemented in any vehicle, a two-wheeled vehicle, a three wheeled vehicle, a multi-wheeled vehicle, such as, car, bus, truck, train, etc., ships, and aeroplanes. The combination of the rotatable display unit and the visor unit results in a safe ride of the rider, aesthetically appealing, modular, resulting in ease in manufacture, assembling, maintenance, of the vehicle and improved durability of the vehicle.

Improvements and modifications may be incorporated herein without deviating from the scope of the invention.

### LIST OF REFERENCE NUMERALS

100—handle bar assembly of a vehicle
101—handle bar cover
102a—right handle bar grip
102b—right handle bar brake lever
103a—left handle bar grip
103b—left handle bar brake lever
104—cluster of switches
105—rotatable display unit
105a, 105b-display faces
105a—analog display nit
105b—electronic display unit
106—visor unit
107—dashboard assembly
108—rear view mirror
200—dashboard control system
201—wireless communication card
202—secondary display unit
203—front end IC/NFC controller
204—controller
205—secondary display drive unit
206—visor drive unit
207—rotatable display drive unit
208—analog dial drive unit
209—drive unit
210—power supply and protection circuit
211—backlight circuit
212—LED tell tales
213—CAN transceiver circuit
214—signal conditioning unit
215—sensors
216—user device
216a—user application
217—control inputs
218—connectivity supporting hardwares
219—display interface
220—secondary sensors
221—SOC module
222—microcontroller
223—vehicle control unit
301—motor controller of visor unit
302—motor of visor unit
303—visor unit rotation mechanism
304—angle sensor of visor unit
401—motor controller of rotatable display drive unit
402—motor of rotatable display drive unit
403—rotatable display drive unit rotation mechanism
404—angle sensor of rotatable display drive unit

1-33. (canceled)

34. A dashboard control system of a vehicle comprising:
one or more sensors positioned in the vehicle for generating sensor outputs;
one or more control inputs located on at least one of the vehicle and a user device communicatively coupled to the vehicle; and
a dashboard assembly positioned in the vehicle facing a rider of the vehicle, the dashboard assembly comprising at least one visor unit coupled with a rotatable display unit with at least one display face, wherein
the rotatable display unit comprises at least one drive unit and at least one controller for controlling operation of at least one of the at least one visor unit and the rotatable display unit, based on the sensor outputs and the one or more control inputs.

35. The dashboard control system as claimed in claim 34, wherein the at least one visor unit is configured to at least partially cover the rotatable display unit underneath and the at least one visor unit is controlled by the at least one controller to move in one of an opening direction and a closing direction to one of expose and cover the rotatable display unit.

36. The dashboard control system as claimed in claim 34, wherein the at least one visor unit comprises a wireless communication board for providing keyless access to the vehicle and a secondary display unit for displaying vehicle status information, alerts, and notifications and branding of the vehicle.

37. The dashboard control system as claimed in claim 34, wherein the at least one drive unit comprises a secondary display drive unit, a visor drive unit, an analog dial drive unit, and a rotatable display drive unit.

38. The dashboard control system as claimed in claim 37, wherein the visor drive unit operably coupled to the at least one controller comprises at least one angle sensor and a motor controller operably coupled to a motor for positioning the visor unit at a selected position.

39. The dashboard control system as claimed in claim 37, wherein the rotatable display drive unit operably coupled to the at least one controller comprises at least one angle sensor, a motor controller, and a motor for positioning the rotatable display unit with a selected display face.

40. The dashboard control system as claimed in claim 34, wherein the at least one display face comprises an analog display unit, an electronic display unit for displaying vehicle status information, alerts, and notifications, and a vehicle body element in flush layout with mounting location of the dashboard assembly in the vehicle.

41. The dashboard control system as claimed in claim 40, wherein the electronic display unit comprises a display interface communicatively coupled to at least one display controller, at least one secondary sensor, and one or more connectivity supporting hardwares.

42. The dashboard control system as claimed in claim 34, wherein the at least one controller of the dashboard assembly controls one or more of a keyless access of the vehicle using the at least one visor unit, rotation of the rotatable display unit, movement of the at least one visor unit in an opening direction and a closing direction, and positioning of the rotatable display unit and the visor unit at a position selected by the rider of the vehicle, based on the control inputs and the sensor outputs.

43. The dashboard control system as claimed in claim 34, wherein the control inputs comprise one or more of switches provided on the dashboard assembly, switches on the handle bar cover of the vehicle, switches on the vehicle body panels proximal to the rider of the vehicle, an input in a user application of the user device connected to the vehicle, a voice command to the at least one visor unit, and a voice command to the rotatable display unit.

44. The dashboard control system as claimed in claim 34, wherein the control inputs are configured to:
select a mode of operation of the visor unit,
select a mode of operation of the rotatable display unit,
select a display face of the rotatable display unit to be facing the rider of the vehicle, and
select a default display face of the rotatable display unit facing the rider of the vehicle.

45. A method for controlling operation of a dashboard assembly of a vehicle, the method implemented by a dashboard control system in communication with a vehicle control unit, the dashboard control system comprising one or more sensors positioned in the vehicle for generating sensor output, one or more control inputs located on at least one of the vehicle and a user device communicatively coupled to the vehicle, and the dashboard assembly positioned in the vehicle facing a rider of the vehicle, the dashboard assembly comprising at least one visor unit coupled with a rotatable display unit with at least one display face, wherein the rotatable display unit comprises at least one drive unit and at least one controller for controlling operation of at least one of the at least one visor unit and the rotatable display unit, based on the sensor output and the one or more control inputs, the method comprising the steps of:
authorizing access to the vehicle based on an input from a user device on the visor unit by the at least one controller;
actuating the visor unit for moving in one of an opening direction and a closing direction, by the at least one controller based on at least one of the sensor output, the one or more control inputs, and a vehicle condition; and
actuating the rotatable display unit for rotating and displaying a selected display face by the at least one controller, based on the sensor output and a selection of the one or more control inputs.

46. The method as claimed in claim 45, further comprises authorizing the rider by the at least one controller based on the vehicle condition.

47. The method as claimed in claim 45, wherein the vehicle condition is one of a vehicle ignition ON condition, a vehicle ignition OFF condition, a vehicle stationary condition, and a vehicle running condition.

48. The method as claimed in claim 47, further comprises changing the vehicle condition to vehicle ignition OFF condition by the vehicle control unit on determining vehicle ignition ON condition and actuating the visor unit for moving in the closing direction by the at least one controller based on the vehicle ignition OFF condition.

49. The method as claimed in claim 47, further comprises changing the vehicle condition to vehicle ignition ON condition by the vehicle control unit on determining vehicle ignition OFF condition and actuating the visor unit for moving in the opening direction by the at least one controller based on the vehicle ignition ON condition.

50. The method as claimed in claim 48, comprises disabling a drive mode of the vehicle by the vehicle control unit, prior to actuating the visor unit for moving in the one of the opening direction and the closing direction by the at least one controller.

51. The method as claimed in claim 49, comprises enabling a drive mode of the vehicle by the vehicle control unit, after at least partial movement of the visor unit in the opening direction on actuation by the at least one controller.

52. The method as claimed in claim 46, comprises displaying vehicle authorization status information and vehicle status information by a secondary display unit of the visor unit, based on the authorization of the rider by the at least one controller.

53. The method as claimed in claim 52, further comprising displaying the rotatable display unit status information on the secondary display unit by the at least one controller on determining a fault in positioning the selected display face of the rotatable display unit.

54. The method as claimed in claim 52, further comprising displaying the vehicle status information and visor unit fault status on the secondary display unit by the at least one controller on determining a fault in driving the visor unit.

55. The method as claimed in claim 45, further comprising actuating the visor unit to move in the closing direction by the at least one controller, prior to actuation of the rotatable display unit for rotating and displaying the selected display face.

56. The method as claimed in claim 54, further comprising determining the display face of the rotatable display unit facing the rider of the vehicle by the at least one controller, prior to actuating the visor unit to move in the closing direction for actuation of the rotatable display unit for rotating and displaying the display face.

57. The method as claimed in claim 45, wherein the control inputs comprise one or more of switches provided on the dashboard assembly, switches on the handle bar cover of the vehicle, switches on the vehicle body panels proximal to the rider of the vehicle, an input in a user application of the user device connected to the vehicle, a voice command to the at least one visor unit, and a voice command to the rotatable display unit.

58. The method as claimed in claim 45, wherein the display face comprises an analog display unit, an electronic display unit for displaying vehicle status information, alerts, and notifications, and a vehicle body element in flush layout with mounting location of the dashboard assembly in the vehicle.

59. The method as claimed in claim 45, wherein the control inputs are configured to select a mode of operation of the visor unit, select a mode of operation of the rotatable display unit, select a display face of the rotatable display unit to be facing the rider of the vehicle, and select a default display face of the rotatable display unit facing the rider of the vehicle.

60. The method as claimed in claim 45, wherein the at least one drive unit comprises a secondary display drive unit, a visor drive unit, an analog display drive unit, and a rotatable display drive unit.

61. The method as claimed in claim 60, wherein actuating the visor unit comprises actuating a motor controller operably coupled to a motor of the visor drive unit by the at least one controller based on the one or more control inputs, a rotation direction, status of fault registers of the motor controller, and the sensor output from at least one angle sensor of the visor drive unit for positioning the visor unit at a selected position.

62. The method as claimed in claim 61, actuating the visor unit for positioning the visor unit at the selected position comprises computing an angle of positioning the visor unit by the at least one controller and driving the motor controller operably coupled to the motor of the visor drive unit to the computed angle, based on the sensor output and almanac information of a day.

63. The method as claimed in claim 61, actuating the visor unit for positioning the visor unit at the selected position comprises receiving visor angle as an input from one of the one or more control inputs and driving the motor controller operably coupled to the motor of the visor drive unit to the received visor angle.

64. The method as claimed in claim 60, wherein actuating the rotatable display unit comprises actuating a motor controller operably coupled to a motor of the rotatable display drive unit by the at least one controller based on the one or more control inputs, a preconfigured rotation direction, status of fault registers of motor controller, and the sensor output from at least one angle sensor of the rotatable display drive unit for displaying the selected display face to the rider of the vehicle.

65. The method as claimed in claim 64, actuating the rotatable display unit for positioning the display face of the rotatable display unit comprises computing an angle of rotation of the rotatable display unit by the at least one controller based on the selected display face by the rider and driving the motor controller operably coupled to the motor of the rotatable display drive unit to the computed angle.

66. The method as claimed in claim 61, comprising actuating the motor controller by the at least one controller to control both the visor unit and the rotatable display unit.
